(19) United States
(12) Patent Application Publication
(10) Pub. No.: US 2023/0130040 A1
(43) Pub. Date: Apr. 27, 2023

(54) Sensing system

(71) Applicant: ams International AG, Jona (CH)

(72) Inventors: Miguel Bruno VAELLO PAÑOS, Zurich (CH); Daniel FURRER, Gebenstorf (CH); Javier Miguel SÁNCHEZ, Zurich (CH); Stephan BEER, Schaffhausen (CH)

(21) Appl. No.: 18/001,598

(22) PCT Filed: Jun. 23, 2021
(86) PCT No.: PCT/EP2021/067256

§ 371 Date: Dec. 13, 2022

(30) Foreign Application Priority Data
Jun. 30, 2020 (GB) 2010008.7

(51) Int. Cl. G01S 17/34; G01S 7/4915

(52) U.S. Cl. CPC G01S 17/34; G01S 7/4915

(57) ABSTRACT

A sensing system is disclosed for performing distance measurements. The sensing system may include an emitter configured to emit electromagnetic radiation modulated at a known frequency. The sensing system may further include a detector configured to sample incident electromagnetic radiation at the known frequency, convert the sampled electromagnetic radiation into charge carriers, and collect the charge carriers in a storage component to produce an electronic signal. The sensing system may include a processor configured to determine a correction by applying a non-linear polynomial function to the electronic signal.

### CROSS-REFERENCE TO RELATED APPLICATIONS

The present application is a national stage entry according to 35 U.S.C. § 371 of PCT application No.: PCT/EP2021/067256 filed on Jun. 23, 2021; which claims priority to British patent application GB 2010008.7 filed on Jun. 30, 2020; all of which are incorporated herein by reference in their entirety and for all purposes.

### TECHNICAL FIELD

The disclosure relates to a sensing system suitable for use in an electronic device, particularly but not exclusively to an indirect time-of-flight sensing system or a proximity sensing system suitable for use in a mobile phone.

### BACKGROUND

Known sensing systems comprise an emitter configured to emit electromagnetic radiation and a detector configured to detect incident electromagnetic radiation. Some known sensing systems are configured to perform indirect time-of-flight measurements. This involves the emitter emitting electromagnetic radiation having a known modulation. At least some of the emitted electromagnetic radiation reflects from a target and returns towards the sensing system. At least some of the reflected electromagnetic radiation is incident on, and detected by, the detector. The detector samples the incident electromagnetic radiation at the known frequency and produces a detection signal. A processor of the known sensing system is used to determine a phase difference between the emitted electromagnetic radiation and the sampled electromagnetic radiation. As the modulation frequency is known, the measured phase difference corresponds to the time-of-flight of the emitted electromagnetic radiation. The time-of-flight information is used to determine a distance between the sensing system and the target.

A problem associated with known sensing systems is that electromagnetic radiation from other sources (such as sunlight in outdoor environments and electronic lights in indoor environments) contributes to the detected signal as background noise. The background noise decreases a measurement accuracy of the known sensing system.

Another problem associated with known sensing systems is that imperfections exist in the sampling of the electromagnetic radiation, the conversion of the sampled electromagnetic radiation into the detection signal and subsequent handling of the detection signal. For example, imperfections in the electronic systems within the detector that are used to convert incident electromagnetic radiation into the detection signal may introduce measurement errors that reduce an accuracy of measurement performed by the known sensing system.

### SUMMARY

In general, a non-linear polynomial function may be applied to an electronic signal generated by the detector. This advantageously at least partially corrects for the abovementioned problems and improves an accuracy of the sensing system.

There is provided a sensing system for performing distance measurements comprising an emitter configured to emit electromagnetic radiation modulated at a known frequency. The sensing system comprises a detector configured to sample incident electromagnetic radiation at the known frequency and convert the sampled electromagnetic radiation into charge carriers. The detector is configured to collect the charge carriers in a storage component to produce an electronic signal. The sensing system further comprises a processor configured to determine a correction by applying a non-linear polynomial function to the electronic signal.

Imperfections may exist in the sampling of the electromagnetic radiation and/or the conversion of the sampled electromagnetic radiation into charge carriers and/or the collection of the charge carriers in the storage component.

For example, the detector may sample unwanted background electromagnetic radiation (e.g. ambient light) in combination with reflected modulated electromagnetic radiation that was emitted by the emitter. The unwanted background electromagnetic radiation may be referred to as a background signal. Non-modulated electromagnetic radiation (e.g. light emitted by the sun) and/or modulated electromagnetic radiation generated by sources other than the emitter (e.g. light emitted by electronic lights such as street lamps and/or indoor lighting) may contribute to the background signal. The reflected modulated electromagnetic radiation that was emitted by the emitter may be referred to as a desired signal. The electronic signal may comprise the background signal and the desired signal. The background signal may constitute measurement noise that negatively affects an accuracy of the sensing system. An accuracy of the sensing system may at least partially depend on a ratio between an amplitude of the desired signal and an amplitude of the background signal (i.e. a signal-to-noise ratio). In known sensing systems and methods, the background signal contributes to the calculation of inaccurate distances.

As another example, non-linear charge collection and storage (e.g. non-linear charge transfer) within the detector and/or in-pixel coupling within the detector may contribute a non-linear offset to the electronic signal. In known sensing systems and methods, the non-linear offset contributes to the calculation of inaccurate distances.

A variable of the non-linear polynomial function may be proportional to a non-linear offset to the electronic signal. The non-linear offset may be at least partially dependent upon a non-linear charge transfer in the storage component.

The inventors have discovered that the electronic signal is proportional to the non-linear offset. By applying a non-linear polynomial function to the electronic signal, the negative effects of the background signal and the non-linear offset can be at least partially compensated for, thereby improving an accuracy of the sensing system compared to known sensing systems and methods. The accuracy of the sensing system is significantly improved, particularly at larger distances where a signal-to-noise ratio of the sensing system is relatively low.

Known sensing systems and methods require the use of error-source sensors such as a temperature sensor, a supply voltage sensor and/or a voltage drop sensor to collect error signals for use with a polynomial fit. The known sensing systems and methods do not consider the non-linear offsets discussed above. Known sensing systems and methods require complex systems of multiple sensors to monitor characteristics, resulting in bulky and expensive devices. Known sensing systems and methods neither consider nor account for the problem of the background signal. Known sensing systems and methods require complex and time-consuming calibration processes to populate a lookup table for calculating corrections. Known sensing systems and methods use complex and expensive detection systems comprising sub-pixels. Known sensing systems and methods do not apply non-linear polynomial functions.

The sensing system may be configured to perform indirect time-of-flight measurements. This may involve the emitter emitting continuous wave electromagnetic radiation having a known modulation that reflects from a target. At least some of the reflected electromagnetic may be incident on, and detected by, the detector. The detector may be used to determine a phase difference between the emitted electromagnetic radiation and the detected electromagnetic radiation. As the modulation frequency is known, the measured phase difference may correspond to the time-of-flight of the emitted electromagnetic radiation. The time-of-flight may be used to determine a distance between the sensing system and the target.

The emitter may comprise any kind of electromagnetic radiation source suitable for being incorporated into an electronic device e.g. a diode or a laser such as a vertical cavity surface-emitting laser (VCSEL).

The emitter may be configured to emit continuous wave electromagnetic radiation. The continuous wave electromagnetic radiation is modulated at the known frequency.

The emitter may be configured to emit sinusoidally modulated electromagnetic radiation. Other types of modulation may be used, e.g. square wave modulation, pulsed modulation, etc.

The emitter may be configured to emit infrared electromagnetic radiation. The emitter may be configured to emit visible electromagnetic radiation.

The detector may be configured to measure an amplitude of the sampled electromagnetic radiation. The processor may be configured to determine an amplitude offset of the sampled electromagnetic radiation relative to an amplitude of the emitted electromagnetic radiation.

The detector may be configured to measure a phase of the sampled electromagnetic radiation. The processor may be configured to determine a phase shift of the sampled electromagnetic radiation relative to a phase of the emitted electromagnetic radiation.

The detector may be configured to measure a plurality of amplitudes of the sampled electromagnetic radiation at a plurality of different phases of the sampled electromagnetic radiation.

The detector may comprise one or more pixels. The detector may comprise an array of pixels. The detector may comprise one or more demodulation pixels configured to demodulate the incident electromagnetic radiation. The detector may be configured to demodulate the incident electromagnetic radiation at the known frequency. The demodulation pixels may be referred to as lock-in pixels due to their similarity in function to lock-in amplifiers. The detector may comprise an array of demodulation pixels.

The detector may operate on a charge-coupled device (CCD) principle and/or a complementary metal-oxide-semiconductor (CMOS) principle.

The charge carriers may be directed towards the storage component using a bias voltage. The bias voltage may be modulated (e.g. at a frequency that is substantially equal to the known frequency) such that only charge carriers generated during certain time intervals (corresponding to certain phases of the emitted electromagnetic radiation) are collected by the storage component. Other charge carriers may be directed to a charge dump. The modulating voltage may act as an electronic shutter that operates at substantially the same frequency as the known frequency.

The storage component may comprise a CCD gate. The storage component may comprise a p-n junction. The storage component may comprise an integration gate. The electronic signal may be an integration gate signal. The integration gate signal may correspond to an amount of charge that is stored in the integration gate. The non-linear offset(s) may be at least partially compensated for by adjusting the electronic signal(s) in accordance with a non-linear polynomial function whose variable (i.e. the electronic signal(s)) is proportional to the non-linear offset(s). Known sensing systems and methods do not use the integration gate signal to calculate any corrections.

The detector may comprise a single photon avalanche diode (SPAD). The detector may comprise a plurality of SPADS. The detector may comprise an array of SPADs.

The storage component may comprise a counter configured to count the number of breakdown events triggered in the array of SPADs.

The processor may be configured to use the correction and the electronic signal to determine a value indicative of a distance to and/or a reflectivity of a target.

The non-linear polynomial function may be stored in a firmware of the sensing system.

The non-linear polynomial function may be calculated by dedicated circuitry within the sensing system.

The electronic signal may be indicative of how full of charge carriers the storage compartment is.

The electronic signal may be indicative of a first amplitude of the sampled electromagnetic radiation at a first phase of the sampled electromagnetic radiation.

The electronic signal may be indicative of a plurality of amplitudes of the sampled electromagnetic radiation at a plurality of different phases of the sampled electromagnetic radiation.

The processor may be configured to use the electronic signal and the correction to calculate an amplitude offset between the emitted electromagnetic radiation and the reflected electromagnetic radiation.

The electronic signal may be indicative of a difference between a first amplitude at a first phase of the sampled electromagnetic radiation and a second amplitude at a second phase of the sampled electromagnetic radiation.

The electronic signal may be indicative a difference between a fourth amplitude at a fourth phase and a second amplitude at a second phase (e.g. A₃−A₁). As another example, the electronic signal may comprise a difference between a first amplitude at a first phase and a third amplitude at a third phase (e.g. A₀−A₂). The electronic signal may comprise a difference between any combinations of the measured amplitudes at the different phases. The electronic signal comprising a difference in amplitudes at different phases may be used when calculating the amplitude 220 (A) of the reflected signal 210 and/or the phase (φ) of the reflected signal 210 as described above. A non-linear polynomial function may be applied to the electronic signal in order to improve an accuracy of said calculations (described in more detail below).

The processor may be configured to apply the non-linear polynomial function to the electronic signal only above a threshold value of the electronic signal.

The threshold value of the electronic signal may be determined by calibration (e.g. illuminating different targets at different distances electromagnetic radiation having different characteristics (e.g. wavelength, power, etc.) and/or statistical analysis of the results of the calibration. The threshold value may be stored in a memory of the sensing system.

The non-linear polynomial function may comprise an adaptive function. The adaptive function may separate the non-linear polynomial function into multiple intervals. The intervals may correspond to different threshold values. The adaptive function may be configured to provide a plurality of threshold values (e.g. each corresponding to an interval of the adaptive function). The adaptive function may include a term that is dependent on the incident electromagnetic radiation.

The non-linear polynomial function comprise a step function. The step function may comprise a linear combination of indicator functions of intervals of the non-linear polynomial function. The step function may be configured to provide a plurality of threshold values (e.g. each corresponding to a step of the step function).

The threshold value may correspond to an electronic signal value at which the collection of charge carriers in the storage component becomes non-linear. When the storage component begins to become saturated with charge carriers, the collection and storage of charge carriers in the storage component may become non-linear.

The background signal may contribute to the saturation of the storage component. The saturation of the storage component may effectively compress at least part of the electronic signal, and thereby contribute to a non-linear offset experienced by the electronic signal. This non-linear offset is at least partially corrected for by the correction.

The non-linear polynomial function may be a second order polynomial function.

There may be a balance to be struck between computing power and cost and/or complexity of the sensing system. A more complex polynomial function (e.g. third order or higher) may be used to provide more accurate correction values. However, this would require greater computing power to be incorporated into the sensing system. The inventors have discovered that a second order polynomial function offers an advantageous balance between providing significant accuracy improvements across a broad range of applications and avoiding an overly complex and/or costly sensing system.

The second order polynomial function may have the following form:

y=p₂·x²+p₁·x+p₀

where y is the correction, x is the electronic signal and p₀, p₁, and p₂ are coefficients that are indicative of a non-linear offset experienced by the electronic signal.

The second order polynomial function may have the following form:

y=p₂·x²+p₁·x+(p₀+xtalkᵢ)

where y is the correction, x is the electronic signal, p₀, p₁, and p₂ are coefficients that are indicative of a non-linear offset experienced by the electronic signal, and xtalkᵢ is indicative of a portion of the emitted electromagnetic radiation that is reflected by a component of the sensing system and/or a components of an electronic device incorporating the sensing system.

The detector may be configured to sample a plurality of different phases of the incident electromagnetic radiation at the known frequency. The detector may be configured to convert the sampled plurality of different phases into charge carriers. The detector may be configured to collect the charge carriers in a plurality of storage components, wherein the processor is configured to determine a plurality of corrections by applying a plurality of non-linear polynomial functions to the plurality of electronic signals.

Imperfections may exist in the collection of the charge carriers amongst different storage components. For example, differences between the electronic responses of the plurality of storage components and/or differences between different paths taken by the charge carriers to reach the different storage components may contribute further non-linear offsets to each of the plurality of electronic signals.

The inventors have discovered that each of the electronic signals are proportional to the corresponding non-linear offsets. By applying a non-linear polynomial function to the plurality of electronic signals, the negative effects of the further non-linear offsets can be at least partially compensated for, thereby improving an accuracy of the sensing system compared to known sensing systems and methods.

The plurality of electronic signals may be different to one another. The plurality of electronic signals may be referred to as differential modes.

The non-linear polynomial functions may be the same for each electronic signal. The non-linear polynomial functions may vary between different electronic signals.

Each storage compartment may correspond to a different phase of the sampled electromagnetic radiation.

A bias voltage may be modulated (e.g. at a modulation frequency that is substantially equal to the known frequency) such that only charge carriers generated during certain time intervals (corresponding to the different phases of the emitted electromagnetic radiation) travel to and become collected by the plurality of storage components. The bias voltage may vary such that charge carriers generated by the different phases of the incident electromagnetic radiation are collected by different storage compartments. That is, a first storage compartment may be configured to collect charge carriers generated by a first phase, a second storage compartment may be configured to collect charge carriers generated by a second phase, etc.

The plurality of storage components may comprise a plurality of CCD gates.

The plurality of storage components may comprise a plurality of p-n junction diodes.

The plurality of storage components may comprise a plurality of integration gates. The plurality of electronic signals may comprise a plurality of integration gate signals. Each integration gate signal may correspond to an amount of charge that is stored in each integration gate.

The plurality of storage components may comprise a plurality of counters configured to count the number of breakdown events triggered in the array of SPADs. Each counter may correspond to a different phase.

The processor may be configured to apply the plurality of non-linear polynomial functions to the plurality of electronic signals only above a plurality of threshold values of the plurality of electronic signals.

The threshold values may be different for different electronic signals.

The non-linear polynomial function may comprise an adaptive function. The adaptive function may separate the non-linear polynomial function into multiple intervals. The intervals may correspond to different threshold values. The adaptive function may be configured to provide a plurality of threshold values (e.g. each corresponding to an interval of the adaptive function). The adaptive function may include a term that is dependent on the incident electromagnetic radiation.

The non-linear polynomial function comprise a step function. The step function may comprise a linear combination of indicator functions of intervals of the non-linear polynomial function. The step function may be configured to provide a plurality of threshold values (e.g. each corresponding to a step of the step function).

The processor may be configured to subtract a common-mode signal from the plurality of electronic signals before applying the plurality of non-linear polynomial functions to the plurality of electronic signals.

The electromagnetic radiation sampled by the detector may comprise a component of interest (e.g. electromagnetic radiation modulated at the known frequency) and a component of non-modulated background signal (e.g. ambient light from the sun). The common-mode of the stored charge corresponds to the background signal. By subtracting the common-mode signal in the charge domain, the negative effects caused by the background signal are at least partially corrected.

Furthermore, imperfections may exist in the subtraction of the common-mode signal. For example, a finite common-mode suppression ratio of the sensing system may contribute further non-linear offsets to each of the plurality of electronic signals. Due to these imperfections in the production and processing of electronic signals, at least some of the background signal may remain in the electronic signal after the subtraction of the common-mode signal, which contributes to measurement errors. Known sensing systems and methods neither consider nor attempt to account for the remaining background signal.

The inventors have discovered that each of the electronic signals are proportional to the corresponding further non-linear offsets. By applying a non-linear polynomial function to the plurality of electronic signals, the negative effects of the further non-linear offsets can be at least partially compensated for, thereby improving an accuracy of the sensing system compared to known sensing systems and methods.

There is provided an electronic device comprising the sensing system of any preceding aspect.

The electronic device may be portable. The electronic device may be a computing device such as a mobile phone or a tablet computer. The electronic device may be a telecommunications system. The electronic device may be a medical device such as a diagnostics device. The electronic device may be suitable for use within the automotive industry, robotics, manufacturing, and automated processes.

There is provided a method of performing a distance measurement comprising emitting electromagnetic radiation modulated at a known frequency, sampling incident electromagnetic radiation at the known frequency, converting the sampled electromagnetic radiation into charge carriers, collecting the charge carriers to produce an electronic signal, and determining a correction by applying a non-linear polynomial function to the electronic signal.

A variable of the non-linear polynomial function may be proportional to a non-linear offset to the electronic signal. The non-linear offset may be at least partially dependent upon a non-linear charge transfer associated with collecting the charge carriers.

The electronic signal may be indicative of a first amplitude of the sampled electromagnetic radiation at a first phase of the sampled electromagnetic radiation.

The electronic signal may be indicative of a plurality of amplitudes of the sampled electromagnetic radiation at a plurality of different phases of the sampled electromagnetic radiation.

The electronic signal and the correction may be used to calculate an amplitude offset between the emitted electromagnetic radiation and the reflected electromagnetic radiation.

The electronic signal may be indicative of a difference between a first amplitude at a first phase of the sampled electromagnetic radiation and a second amplitude at a second phase of the sampled electromagnetic radiation.

The non-linear polynomial function may be applied to the electronic signal only above a threshold value of the electronic signal.

The threshold value may correspond to an electronic signal value at which the collection of charge carriers becomes non-linear.

Collecting the charge carriers to produce an electronic signal may comprise storing the charge carriers in an integration gate. The electronic signal may be an integration gate signal that corresponds to an amount of charge that is stored in the integration gate.

Emitting electromagnetic radiation modulated at a known frequency may comprise emitting continuous wave electromagnetic radiation modulated at the known frequency.

The non-linear polynomial function may be a second order polynomial function.

The second order polynomial function may have the following form:

y=p₂·x²+p₁·x+p₀

where y is the correction, x is the electronic signal and p₀, p₁, and p₂ are coefficients that are indicative of a non-linear offset experienced by the electronic signal.

The method may comprise sampling a plurality of different phases of the incident electromagnetic radiation at the known frequency. The method may comprise converting the sampled plurality of different phases into charge carriers. The method may comprise collecting the charge carriers to produce a plurality of electric signals. The method may comprise determining a plurality of corrections by applying a plurality of non-linear polynomial functions to the plurality of electronic signals.

The method may comprise subtracting a common-mode signal from the plurality of electronic signals before applying the non-linear polynomial functions to the plurality of electronic signals.

According to another aspect there is provided a computer program comprising computer readable instructions configured to cause a computer to carry out a method according to any preceding aspect.

The computer program may be stored in a memory of the sensing system. The computer program may form part of a firmware of the sensing system.

According to another aspect there is provided a computer readable medium carrying a computer program according to any preceding aspect.

The computer readable medium may form part of the sensing system. The computer readable medium may form part of the processor.

Features of different aspects may be combined together.

### BRIEF DESCRIPTION OF THE DRAWINGS

Some embodiments will now be described by way of example only and with reference to the accompanying drawings, in which:

FIG. 1 schematically depicts a sensing system;

FIG. 2 shows a graph of an emitted electromagnetic signal and a reflected electromagnetic signal along with multiple characteristics thereof used in indirect time-of-fight-measurements;

FIG. 3A schematically depicts a cross-sectional view of a demodulation region of a detector;

FIG. 3B schematically depicts a view from above the demodulation region of FIG. 3A;

FIG. 4A schematically depicts a cross-sectional view of an alternative demodulation region of a detector;

FIG. 4B schematically depicts a view from above the alternative demodulation region of FIG. 4A;

FIG. 5 shows a graph of a non-linear polynomial function applied to an electronic signal to determine corrections;

FIG. 6A shows a graph of distances measured by a known sensing system under different background light conditions;

FIG. 6B shows a graph of distances measured by a sensing system under different background light conditions;

FIG. 7 schematically depicts an electronic device comprising the sensing system of FIG. 1; and,

FIG. 8 shows a flowchart of a method of performing a distance measurement.

Elements that are identical, similar or have the same effect are given the same reference signs in the Figures. The Figures and the proportions of the elements shown in the Figures are not to be regarded as to scale. Rather, individual elements can be shown exaggeratedly large for better representability and/or for better comprehensibility.

### DETAILED DESCRIPTION

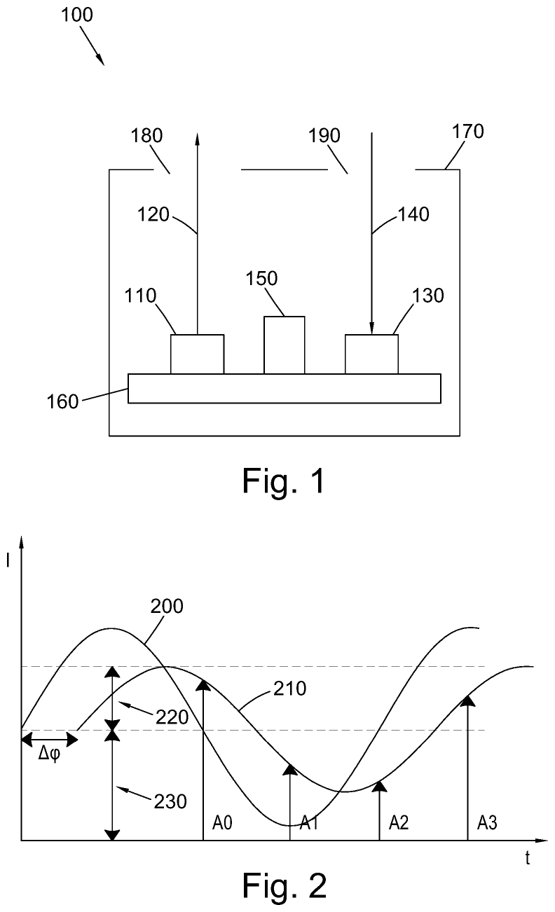

FIG. 1 schematically depicts a sensing system 100. The sensing system 100 comprises an emitter 110 configured to emit continuous wave electromagnetic radiation 120 modulated at a known frequency. The emitter 110 may be any kind of electromagnetic radiation source suitable for being incorporated into an electronic device e.g. a diode or a laser such as a vertical cavity surface-emitting laser (VCSEL). For example, the electromagnetic radiation 120 may be sinusoidally modulated at a known frequency. Other types of modulation may be used, e.g. square wave modulation, pulsed modulation, etc. The electromagnetic radiation may comprise infrared electromagnetic. Alternatively, the electromagnetic radiation may comprise visible radiation.

The sensing system further comprises a detector 130 configured to sample incident electromagnetic radiation 140 at the known frequency. The detector 130 is further configured to convert the sampled electromagnetic radiation 140 into charge carriers which are collected in a storage component (not shown) to produce an electronic signal. The detector 130 is configured to measure an amplitude and a phase of the sampled electromagnetic radiation 140. The detector 130 comprises an array of demodulation pixels (not shown). The demodulation pixels are configured to demodulate the incident electromagnetic radiation 140 at the known frequency. The demodulation pixels may be referred to as lock-in pixels due to their similarity in function to lock-in amplifiers.

The detector 130 may operate on a charge-coupled device (CCD) principle and/or a complementary metal-oxide-semiconductor (CMOS) principle. The detector 130 detects electromagnetic radiation that has been emitted by the emitter 110 after the electromagnetic radiation has exited the sensing system 100, interacted with (e.g. reflected from) an external target (not shown) and propagated back to the detector 130. The detector 130 may comprise any form of photodetector, e.g. a photodiode or a single photon avalanche diode (SPAD).

The sensing system 100 further comprises a processor 150 configured to determine a correction by applying a non-linear polynomial function to the electronic signal. The processor 150 may be configured to determine a phase shift of the sampled electromagnetic radiation relative to a phase of the emitted electromagnetic radiation.

In the example of FIG. 1, the sensing system 100 comprises a printed circuit board 160, on which the emitter 110, detector 130 and processor 150 are located. Electrical connections (not shown) such as layer of Copper routing and vias exist within the printed circuit board 160. The electrical connections allow signals to travel between different component of the sensing system 100. For example, the electrical signal may travel from the detector 130 to the processor 150 through the electrical connections.

The components of the sensing system 100 are contained within a housing 170. The housing 170 includes apertures 180, 190 for allowing emitted electromagnetic radiation 120 to exit the sensing system 100 and for allowing incident electromagnetic radiation 140 to enter the sensing system 100 and be incident on the detector 130. The sensing system 100 may comprise one or more optical assemblies (not shown) configured to adjust a characteristic of the emitted electromagnetic radiation 120 and/or the incident electromagnetic radiation 140. The optical assemblies may be collocated with the apertures 180, 190. The optical assembly may comprise a transmissive (e.g., glass) carrier for supporting an optical element (not shown). The optical element may comprise a micro-lens array (MLA, an optical diffuser, a lens, a refractive or diffractive optical element, a spectral filter, a polarizing filter, etc.

The sensing system 100 is configured to perform indirect time-of-flight measurements to calculate distances to targets. The sensing system 100 is suitable for being incorporated into an electronic device such as, for example, a mobile phone or a tablet computer. The sensing system 100 may be used for relatively high accuracy distance measurements. The sensing system 100 may alternatively be used as a proximity sensing system in which the emitter 110 emits electromagnetic radiation, at least some of which exits the sensing system 100 and interacts with (e.g. reflects from) from one or more external objects before being incident on the detector 130 for detection. The amount of radiation emitted by the emitter 110 may be compared to the amount of radiation detected by the detector 130 in order to determine a distance between the sensing system 100 and the one or more external objects. The proximity sensing system may be used for relatively low accuracy measurements.

FIG. 2 shows a graph of an emitted electromagnetic signal 200 and a reflected electromagnetic signal 210 along with multiple characteristics thereof used in indirect time-of-fight measurements. The vertical axis represents an amplitude of the electromagnetic signals 200, 210 and the horizontal axis represents time. As can be seen, the amplitude of the signals 200, 210 modulates sinusoidally over time. An amplitude 220 of the reflected signal 210 is less than an amplitude of the emitted signal 200 due to optical losses, e.g. a non-perfect reflectivity of a target from which the emitted signal 200 reflects. An amplitude offset 230 between the emitted signal 200 and reflected signal 210 may be indicative of a reflectivity of the target. A phase shift OA between the emitted signal 200 and the reflected signal 210 may be indicative of a distance between the sensing system and the target.

A time-of-flight of the reflected signal 210 may be determined using the following equation:

$$τ = \frac{Δφ}{2 π f}$$

where Δφ is the phase shift Δφ between the emitted signal 200 and the reflected signal, and f is a modulation frequency of the emitted signal 200.

In the example of FIG. 2, four different phases A0-A3 are selected for consideration. A lock-in pixel of the detector samples the reflected signal at the four different phases (A0-A3) and stores the resulting detected charge carriers in four different storage compartments. An amplitude offset 230 between the emitted signal 200 and the reflected signal 210 may be determined using the following equation:

$$B = \frac{{A}_{0} + {A}_{1} + {A}_{2} + {A}_{3}}{n}$$

where A₀, A₁, A₂ and A₃ are amplitudes of the reflected signal 210 at four different phases and n is the number of samples taken in the modulation period (in this example, n=4). This information may be used to construct a black and white image of a scene sensed by the detector.

An amplitude 220 of the reflected signal 210 may be determined using the following equation:

$$A = \frac{\sqrt{{[ {A}_{3} - {A}_{1} ]}^{2} + {[ {A}_{0} - {A}_{2} ]}^{2}}}{2}$$

This information may be used to determine a reliability of measurements performed using the sensing system.

A phase of the reflected signal 210 may be determined using the following equation:

$$φ = {tan}^{- 1} ( \frac{{A}_{3} - {A}_{1}}{{A}_{0} - {A}_{2}} )$$

This information may be used to determine the phase shift Δφ between the emitted signal 200 and the reflected signal 210. In turn, the phase shift Δφ may be used to determine a distance between the sensing system and a target that reflected the reflected signal 210.

As previously discussed, the detector converts the sampled electromagnetic radiation into charge carriers (e.g. electrons and/or holes) which are collected in a storage component to produce an electronic signal. The storage component may be referred to as a tap. The storage component may be implemented as CCD gate or a p-n junction diode. The storage component may be referred to as an integration gate. The resulting electronic signal may be referred to as an integration gate signal. The integration gate signal may correspond to an amount of charge that is stored in the integration gate. The electronic signal or the integration gate signal may take the form of a voltage.

The electronic signal may comprise one or more amplitudes (e.g. A0, A1, A2 and/or A3) of the reflected signal 210 at one or more different phases of the reflected signal 210. The electronic signal comprising the one or more amplitudes (e.g. A0, A1, A2 and/or A3) of the reflected signal 210 at one or more different phases of the reflected signal 210 may be used to calculate the amplitude offset 230 (B) as described above.

The electronic signal may comprise a difference between two or more amplitudes of the reflected signal 210 at two or more different phases of the reflected signal 210. For example, the electronic signal may be comprise a difference between a fourth amplitude at a fourth phase and a second amplitude at a second phase (e.g. A₃−A₁). As another example, the electronic signal may comprise a difference between a first amplitude at a first phase and a third amplitude at a third phase (e.g. A₀−A₂). The electronic signal may comprise a difference between any combinations of the measured amplitudes at the different phases. The electronic signal comprising a difference in amplitudes at different phases may be used when calculating the amplitude 220 (A) of the reflected signal 210 and/or the phase (φ) of the reflected signal 210 as described above. A non-linear polynomial function may be applied to the electronic signal in order to improve an accuracy of said calculations (described in more detail below).

The charge carriers generated in a photosensitive region of the detector may be directed towards the storage component using a bias voltage. The bias voltage may be modulated (e.g. at a frequency that is substantially equal to the known modulation frequency of the emitted electromagnetic radiation) such that only charge carriers generated during certain time intervals (corresponding to certain phases of the emitted electromagnetic radiation) are collected by the storage component. Other charge carriers may be directed to a charge dump. The modulating voltage may effectively act as an electronic shutter that operates at substantially the same frequency as the known modulation frequency of the emitted electromagnetic radiation.

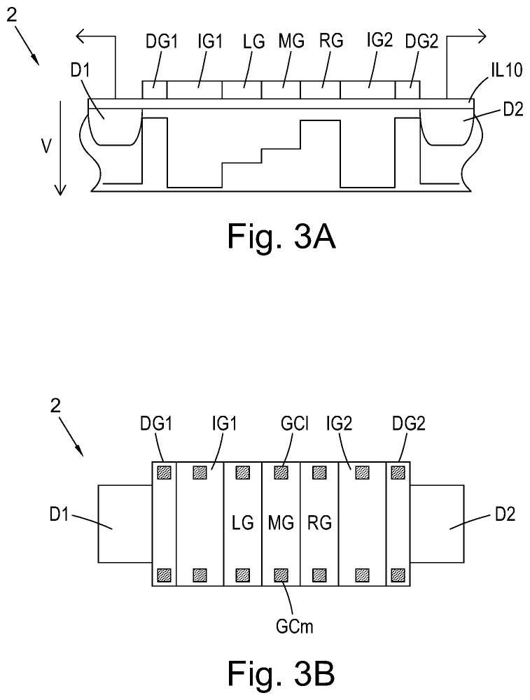

FIG. 3 shows different views of an example of a demodulation region 2 of a detector based on a charge-coupled device architecture comprising two storage compartments. FIG. 3A schematically depicts a cross-sectional view of a demodulation region of a detector. FIG. 3B schematically depicts a view from above the demodulation region of FIG. 3A. The demodulation region comprises a gate structure with three consecutive gates, i.e. a left gate LG, a middle gate MG and a right gate RG. A first integration gate IG1 is located to the left of the left gate LG and a first decoupling gate DG1 is located to the left of the first integration gate IG1. A second integration gate IG2 is located to the right of the right gate RG and a second decoupling gate DG2 is located to the right of the second integration gate IG2. In the example of FIGS. 3A and 3B, two gate contacts GCI, GCm for applying bias voltages are provided for each gate. As can be seen in FIG. 3A, a potential barrier system may be constructed across the demodulation region of the detector. The potential barrier system may act as a conduction channel configured to direct generated charge carriers to different gates of the demodulation region.

Photo-generated charges coming from the detection region are fed into the demodulation stage below the middle gate MG. The adjacent left gate and right date LG, RG may be used to activate either the left or the right conduction channel respectively for demodulation purposes, respectively. Such an activation may involve setting the potential of one of the left gate LG or the right gate RG higher than the potential of the middle gate MG and to set the potential of the other gate smaller than the potential of the middle gate MG. An illustration of the potentials applied to the different gates at a given time is shown in FIG. 3A. In this particular example, when the left gate LG has a higher potential than the middle gate MG, a left conduction channel is used. A conduction channel may be defined by the succession of gates between a first and a second gate. An increased potential between the first gate and the second gate moves the charge carriers from the first gate to the second gate. A conduction channel may be activated by a high voltage signal when a p-doped semiconductor substrate is used.

On both sides the particular charge carriers are stored in the first integration gate IG1 or the second integration gate IG2. The first and second decoupling gates DG1 and DG2 inhibit the ability of the charge carriers to diffuse uncontrollably to output nodes D1, D2. The output nodes D1, D2 may be referred to as sense nodes or diffusion regions. When the charge carriers that are accumulated in one of the integration gates IG1, IG2 are to be transferred to the output nodes D1, D2 of the demodulation region, the potential level of the integration gates IG1, IG2 and of the left and right gates LG, RG are set to the potential level of the decoupling gates DG1, DG2 enabling the diffusion of the charge carriers to the output nodes D1, D2.

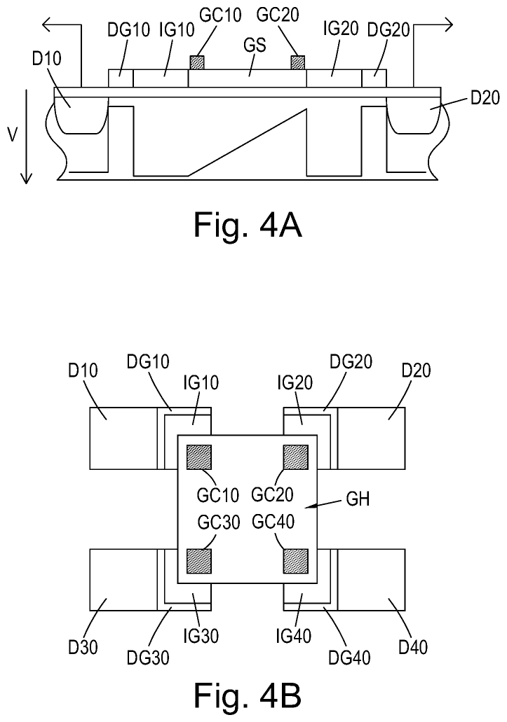

In the example of FIG. 3, the detector comprised two storage compartments for collecting charge carriers. FIG. 4 shows two different views of an example of a demodulation region of a detector based on a charge-coupled device architecture comprising four storage compartments. FIG. 4A schematically depicts a cross-sectional view of the alternative demodulation region of a detector. FIG. 4B schematically depicts a view from above the alternative demodulation region of FIG. 4A. This architecture is based on a gate structure with one closed gate GS and four gate contacts GC10-GC40. Located proximate each gate contact GC10-GC40 is an integration gate IG10-IG40 followed by a decoupling gate DG10-DG40. Near each decoupling gate DG10-DG40 is a corresponding output node D10-D40 on a substrate (not shown). An example potential gradient V of the different gates IG10-IG40, DG10-DG40 and output nodes D10-D40 is shown in FIG. 4A. The potential gradient below the closed high-resistive gate GS due to a current flow through the gate itself provides a rapid separation of the injected charge carriers to just one storage compartment comprising an integration gate IG10-IG40. The current is injected below the closed gate GS and between two adjacent contacts GC10, GC20. A conduction channel is realized when applying a potential on one of the gate contacts (e.g. GC10) that is higher than the potential applied to the other gate contacts (e.g. GC20-GC40) of the demodulation region. The charge carriers are thus conducted to the corresponding integration gate (e.g. IG10). In the example of FIG. 4, the structure of the decoupling gates DG10-DG40 inhibits the uncontrollable diffusion of charge carriers to the output nodes (D10-D40). Amplification stages (not shown) may be provided when reading out of the samples to drive capacities of the electronics rapidly. The architecture may comprise a CMOS or CCD device with a gate structure formed of highly resistive gate material GH. The gate material GH may be used to create a lateral electric drift field when a voltage difference is applied to the demodulation region.

The storage compartments and/or the sensor nodes are not identical to each other. That is, imperfections result in small differences within the electronics, and each storage compartment and/or sensor node has its own characteristic response to charge carrier collection and electronic signal readout. Such imperfections may include varying non-linear charge transfer when approaching saturation of the storage compartments, differences between the storage compartments, differences between the paths taken by the charge carriers and/or electronic signals, etc. These imperfections contribute a non-linear offset to the electronic signal that negatively affects the accuracy of measurements performed by the sensing system (particularly at larger distances when the signal-to-noise ratio is not as strong). These non-linear offsets can be at least partially compensated for if each sample or combination of samples (e.g. the differences between samples) is adjusted by a non-linear polynomial function whose variable is proportional to the non-linear offset values.

As previously discussed, the detector may comprise an array of SPADs. In such embodiments, the storage component may comprise a plurality of counters configured to count the number of breakdown events triggered in the array of SPADs. Each counter may be configured to sample breakdown events during certain time intervals that correspond to certain phases of the reflected signal. That is, each counter may correspond to a different phase of the reflected signal.

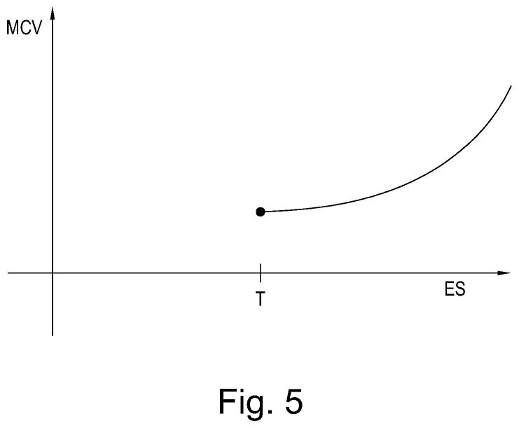

FIG. 5 shows a graph of a non-linear polynomial function applied to an electronic signal to determine corrections. The vertical axis represents a correction MCV. The horizontal axis represents the electronic signal ES. In the example of FIG. 5, the electronic signal is indicative of a mean integration gate signal across four different storage compartments. Applying the non-linear polynomial function to the electronic signal ES may comprise fitting the non-linear polynomial function to the electronic signal. The non-linear polynomial function may be stored in a firmware of the sensing system. Alternatively, the non-linear polynomial function may be calculated by dedicated circuitry within the sensing system.

In the example of FIG. 5, the non-linear polynomial function is applied to the electronic signal above a threshold value T of the electronic signal. The threshold value T of the electronic signal ES may be determined by calibration (e.g. illuminating different targets at different distances electromagnetic radiation having different characteristics (e.g. wavelength, power, etc.). The threshold value T may be stored in a memory of the sensing system. The threshold value T may correspond to an electronic signal value ES at which the collection of charge carriers in the storage component becomes non-linear. That is, when the storage component begins to become saturated with charge carriers, the collection and storage of charge carriers in the storage component may become non-linear due to the build-up of charge in the storage compartment. The background signal may contribute to the saturation of the storage component. The saturation of the storage component may effectively compress at least part of the electronic signal, and thereby contribute to a non-linear offset experienced by the electronic signal. This non-linear offset is at least partially corrected for by the correction.

In the example of FIG. 5, the non-linear polynomial function is a second order polynomial function. The non-linear polynomial function may be of a higher order (e.g. third order or more). The second order polynomial function may take the following form:

y=p₂·x²+p₁·x+p₀
where y is the correction, x is the electronic signal and p₀, p₁, and p₂ are coefficients of the second order polynomial function that are indicative of the non-linear offset experienced by the electronic signal. The coefficients of the polynomial function may be determined by performing a calibration measurement and/or performing a statistical analysis of the results of the calibration. For example, the emitter may be used to illuminate different targets at different distances with electromagnetic radiation having different characteristics (e.g. wavelength, power, etc.).

The second order polynomial function may take the following form:

y=p₂·x²+p₁·x+p₀+xtalkᵢ
where xtalkᵢ is indicative of one or more portions of the emitted signal that are reflected back towards the detector by components (e.g. an optical assembly) of sensing system itself and/or by components (e.g. a cover or screen) of an electronic device comprising the electronic system. For example if the sensing system is incorporated into a mobile phone, the screen of the mobile phone may reflect part of the emitted signal back towards the reflect without ever leaving the mobile phone and being incident on a target. Such internally reflected portions of emitted signal do not provide information on targets located outside of the mobile phone, and therefore negatively affect an accuracy of measurements made using the sensing system. The term xtalkᵢ at least partially accounts for these internally reflected portions of the emitted signal, thereby improving an accuracy of the sensing system.

The term xtalkᵢ may be determined by performing a calibration measurement and/or performing a statistical analysis of the results of the calibration. For example, the emitter may be used to illuminate different targets at different distances with electromagnetic radiation having different characteristics (e.g. wavelength, power, etc.). The term xtalkᵢ may be determined for each sensing system and/or each electronic device that the sensing system is incorporated into. This is because the term xtalkᵢ may vary between different electronic devices that incorporate the sensing system (e.g. different mobile phone glass covers, even within the same or similar mobile phone models). The time-of-flight of these internally reflected portions of the emitted signal is significantly less than the time-of-flight of reflected signals of interest (i.e. signals reflected form a target outside of the sensing system/electronic device). This knowledge may be used to identify such internally reflected signals and calibrate for them using the term xtalkᵢ.

Terms and/or coefficients of the non-linear polynomial function may be stored in a memory of the sensing system. The non-linear polynomial may be applied to electronic signals associated with each storage compartment individually to determine individual corrections for each storage compartment. The processor may be configured to use the correction(s) and the electronic signal(s) to determine values that are indicative of a distance to the target and/or a reflectivity of a target (e.g. an amplitude offset B between the emitted signal and the reflected signal, an amplitude A of the reflected signal, a phase φ of the reflected signal and/or a phase shift Δφ between the emitted signal and the reflected signal).

Scaling may be used to simplify the computation of the correction. That is, to save data and/or computational memory space, some scaling may be implemented, e.g. in a firmware of the sensing system. A distance value may be scaled. For example, instead of performing calculations based on meters (and having to handle a numerical value of, for example, “1000” meters, the numerical value can be scaled by 1*10³ (i.e. 1E3) to be represented in kilometers. This way, the sensing system handles a smaller numerical value of “1” instead of “1000”.

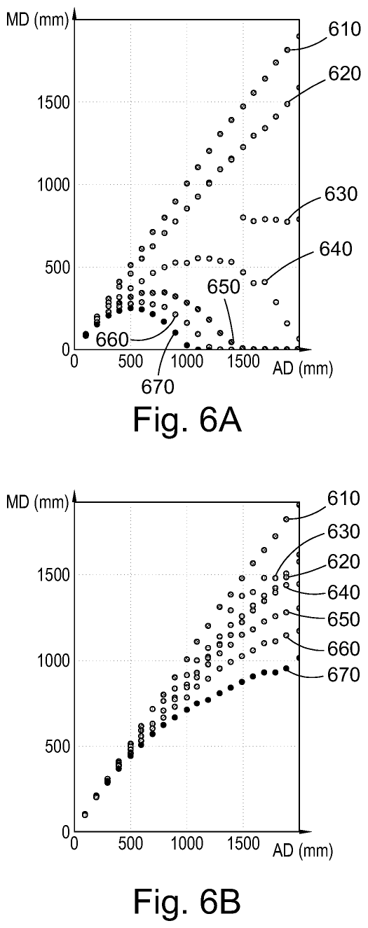

FIG. 6A shows a graph of distances measured by a known sensing system under seven different background light conditions 610-670. The vertical axis represents the measured distance MD between the target and the known sensing system. The horizontal axis represents the actual distance AD between the target and the known sensing system. A lux (i.e. illumination) incident on the known sensing system increases from the first background light condition 610 to the seventh background light condition 670. The amount of lux may correspond to an amount of background or ambient light incident on the known sensing system. That is, the larger the lux, the larger the unwanted background signal is. If the known sensing system was completely accurate, the graph would show a straight line extending diagonally across the graph (i.e. y=x). As can be seen, at larger actual distances AD and/or at increased levels of background light (lux) incident on the sensing system, the measured distances MD begin to become unrepresentative of the actual distances AD. This is because the background signal (i.e. measurement noise) and the non-linear offsets introduced by imperfections in the electronics of the known sensing system negatively affect an accuracy of the known sensing system, and are not accounted for. The accuracy of the known sensing system suffers more at larger actual distances AD and stronger background light conditions where a signal-to-noise ratio of the known sensing system is relatively low.

FIG. 6B shows a graph of distances measured by a sensing system under the same different background light conditions as FIG. 6A. The vertical axis represents the measured distance MD between the target and the known sensing system. The horizontal axis represents the actual distance AD between the target and the known sensing system. A lux (i.e. illumination) incident on the known sensing system increases from the first background light condition 610 to the seventh background light condition 670. The amount of lux may correspond to an amount of background or ambient light incident on the known sensing system. That is, the larger the lux, the larger the unwanted background signal is. As can be seen, the relationship between the actual distance AD and the measured distance MD is much closer to being a straight line extending diagonally across the graph (i.e. y=x) than the known sensing system of FIG. 6A. That is, the sensing system is more accurate than the known sensing system, particularly at larger distances and/or stronger background light conditions. A correction determined by applying a non-linear polynomial function to the electronic signal has been used alongside the electronic signal to at least partially correct for the background signal and non-linear offsets introduced by electronic imperfections, thereby improving an accuracy of the sensing system compared to the known sensing system.

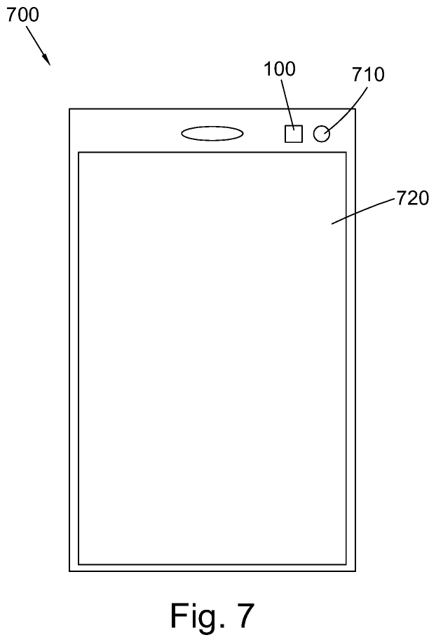

FIG. 7 schematically depicts an electronic device 700 comprising the sensing system 100 of FIG. 1. In the example of FIG. 7 the electronic device 700 is a mobile phone. The mobile phone 700 comprises a camera 710. The sensing system 100 may be used to determine a distance between the camera 710 and an external object (not shown) in order to adjust a focus of the camera 710 to achieve an improved image of the object. The mobile phone comprises a touch screen 720. As another example of a use, the sensing system 100 may be used to determine whether the mobile phone 700 has been placed proximate a user's ear in order to change an input display on the touch screen 720 to avoid unwanted input commands during a phone call.

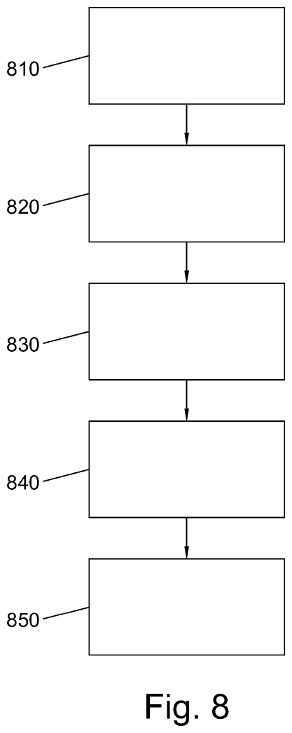

FIG. 8 shows a flowchart of a method of performing a distance measurement. A first step 810 of the method comprises emitting electromagnetic radiation modulated at a known frequency. A second step 820 of the method comprises sampling incident electromagnetic radiation at the known frequency. A third step 830 of the method comprises converting the sampled electromagnetic radiation into charge carriers. A fourth step 840 of the method comprises collecting the charge carriers to produce an electronic signal. A fifth step 850 of the method comprises determining a correction by applying a non-linear polynomial function to the electronic signal.

Embodiments may be used in many different applications, such as for example a smartphone, a tablet computer, a laptop computer, a computer monitor, a car dashboard and/or navigation system, an interactive display in a public space, a home assistant, etc.

### LIST OF REFERENCE NUMERALS

100 sensing system
110 emitter
120 electromagnetic radiation
130 detector
140 incident electromagnetic radiation
150 processor
160 printed circuit board
170 housing
180 aperture
190 aperture
200 emitted electromagnetic signal
210 reflected electromagnetic signal
220 amplitude of reflected signal
230 amplitude offset
A0-A3 phases of reflected signal
2 demodulation region
LG left gate
MG middle gate
RG right gate
IG1 first integration gate
DG1 first decoupling gate
IG2 second integration gate
DG2 second decoupling gate
GCI gate contact
GCm gate contact
V potential
D1 output node
D2 output node
GS closed gate
GC10-GC40 gate contacts
IG10-IG40 integration gates
DG10-DG40 decoupling gates
D10-D40 output nodes
V potential
GH gate material
MCV correction
ES electronic signal value
T threshold value
MD measured distance
AD actual distance
610 first background light condition
620 second background light condition
630 third background light condition
640 fourth background light condition
650 fifth background light condition
660 sixth background light condition
670 seventh background light condition
700 electronic device
710 camera
720 touch screen
810 first method step
820 second method step
830 third method step
840 fourth method step
850 fifth method step

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure that are contemplated as falling within the scope of the appended claims. Each feature disclosed or illustrated in the present specification may be incorporated in any embodiments, whether alone or in any appropriate combination with any other feature disclosed or illustrated herein.

1. A sensing system for performing distance measurements; wherein the sensing system comprises:
an emitter configured to emit electromagnetic radiation modulated at a known frequency;
a detector configured to:
sample incident electromagnetic radiation at the known frequency;
convert the sampled electromagnetic radiation into charge carriers; and,
collect the charge carriers in a storage component to produce an electronic signal,
wherein the sensing system further comprises a processor configured to determine a correction by applying a non-linear polynomial function to the electronic signal.

2. The sensing system of claim 1, wherein a variable of the non-linear polynomial function is proportional to a non-linear offset to the electronic signal, the non-linear offset being at least partially dependent upon a non-linear charge transfer in the storage component.

3. The sensing system of claim 1, wherein the electronic signal is indicative of a plurality of amplitudes of the sampled electromagnetic radiation at a plurality of different phases of the sampled electromagnetic radiation.

4. The sensing system of claim 1, wherein the electronic signal is indicative of a difference between a first amplitude at a first phase of the sampled electromagnetic radiation and a second amplitude at a second phase of the sampled electromagnetic radiation.

5. The sensing system of claim 1, wherein the processor is configured to apply the non-linear polynomial function to the electronic signal only above a threshold value of the electronic signal, wherein the threshold value corresponds to an electronic signal value at which the collection of charge carriers in the storage component becomes non-linear.

6. The sensing system of claim 1, wherein the storage component comprises an integration gate, and wherein the electronic signal is an integration gate signal that corresponds to an amount of charge that is stored in the integration gate.

7. The sensing system of claim 1, wherein the emitter is configured to emit continuous wave electromagnetic radiation modulated at the known frequency.

8. The sensing system of claim 1, wherein the non-linear polynomial function is a second order polynomial function having the following form:
y=p₂·x²+p₁·x+p₀
where y is the correction, x is the electronic signal and p₀, p₁, and p₂ are coefficients that are indicative of a non-linear offset experienced by the electronic signal.

9. The sensing system of claim 1, wherein the non-linear polynomial function is a second order polynomial function having the following form:
y=p₂·x²+p₁·x+(p₀+xtalkᵢ)
where y is the correction, x is the electronic signal, p₀, p₁, and p₂ are coefficients that are indicative of a non-linear offset experienced by the electronic signal, and xtalkᵢ is indicative of a portion of the emitted electromagnetic radiation that is reflected by a component of the sensing system and/or components of an electronic device incorporating the sensing system.

10. The sensing system of claim 1, wherein the detector is configured to:
sample a plurality of different phases of the incident electromagnetic radiation at the known frequency;
convert the sampled plurality of different phases into charge carriers; and,
collect the charge carriers in a plurality of storage components, wherein the processor is configured to determine a plurality of corrections by applying a plurality of non-linear polynomial functions to the plurality of electronic signals.

11. The sensing system of claim 10, wherein the processor is configured to apply the plurality of non-linear polynomial functions to the plurality of electronic signals only above a plurality of threshold values of the plurality of electronic signals.

12. The sensing system of claim 10, wherein the processor is configured to subtract a common-mode signal from the plurality of electronic signals before applying the plurality of non-linear polynomial functions to the plurality of electronic signals.

13. An electronic device comprising the sensing system of claim 1.

14. A method of performing a distance measurement comprising:
emitting electromagnetic radiation modulated at a known frequency;
sampling incident electromagnetic radiation at the known frequency;
converting the sampled electromagnetic radiation into charge carriers;
collecting the charge carriers to produce an electronic signal; and,
determining a correction by applying a non-linear polynomial function to the electronic signal.

15. The method of claim 14, wherein a variable of the non-linear polynomial function is proportional to a non-linear offset to the electronic signal, the non-linear offset being at least partially dependent upon a non-linear charge transfer associated with collecting the charge carriers.

16. The method of claim 14, wherein the electronic signal is indicative of a plurality of amplitudes of the sampled electromagnetic radiation at a plurality of different phases of the sampled electromagnetic radiation.

17. The method of claim 14, wherein the electronic signal is indicative of a difference between a first amplitude at a first phase of the sampled electromagnetic radiation and a second amplitude at a second phase of the sampled electromagnetic radiation.

18. The method of claim 14, wherein the non-linear polynomial function is applied to the electronic signal only above a threshold value of the electronic signal, wherein the threshold value corresponds to an electronic signal value at which the collection of charge carriers becomes non-linear.

19. The sensing system of claim 14, wherein collecting the charge carriers to produce an electronic signal comprises storing the charge carriers in an integration gate, and wherein the electronic signal is an integration gate signal that corresponds to an amount of charge that is stored in the integration gate.

20. (canceled)

21. (canceled)

22. (canceled)

23. (canceled)

24. A computer program comprising computer readable instructions configured to cause a computer to carry out a method according to claim 14.

25. (canceled)
